(19) United States
(12) Patent Application Publication
(10) Pub. No.: US 2025/0094392 A1
(43) Pub. Date: Mar. 20, 2025

(54) STORAGE SYSTEM AND METHOD FOR MANAGING STORAGE SYSTEM

(71) Applicant: Hitachi, Ltd., Tokyo (JP)

(72) Inventors: Hiroki FUJII, Tokyo (JP); Takahiro YAMAMOTO, Tokyo (JP); Akira DEGUCHI, Tokyo (JP)

(21) Appl. No.: 18/596,881

(22) Filed: Mar. 6, 2024

(30) Foreign Application Priority Data
Sep. 15, 2023 (JP) 2023-150327

(51) Int. Cl. G06F 16/21; G06F 16/27

(52) U.S. Cl. CPC G06F 16/214; G06F 16/27

(57) ABSTRACT

To migrate a volume while maintaining a pair. A first node includes a primary volume. A second node includes a secondary volume configured to create a remote copy pair with the primary volume and sets the remote copy using identification information on the primary volume and identification information on the secondary volume. A third node includes a migration destination volume to be a migration destination of the secondary volume. The first node receives a new pair creating request in which the identification information on the volume, the primary identification information on the secondary volume, and information specifying the third node are designated, and creates a new pair between the primary volume and the migration destination volume. The second node deletes the pair of the secondary volume and the primary volume and replaces the identification information on the migration destination volume with the identification information on the secondary volume.

### CROSS-REFERENCE TO RELATED APPLICATION

The present application claims priority from Japanese application JP2023-150327, filed on Sep. 15, 2023, the content of which is hereby incorporated by reference into this application.

### BACKGROUND OF THE INVENTION

### 1. Field of the Invention

The present invention relates to a storage system and a method for managing the storage system.

### 2. Description of Related Art

In the related art, JP2022-169249A (PTL 1) describes a technique for managing a storage system. The publication discloses that “Migration of a volume to which a storage function is applied is performed without copying data written in the volume as a migration target between computers while maintaining the functionality of the storage function.”, “A plurality of computers are connected to each of one or a plurality of physical storage devices so that one or a plurality of physical storage devices can be accessed. Each computer migrates an ownership of the volume as a migration target to a computer as a migration destination. When a volume to be migrated from a first computer to a second computer is an owner volume to which a storage function, in which control data, which is metadata other than area mapping data (metadata about the owner volume, which represents a relationship between a volume area and a storage area), is required for I/O of date instead of or in addition to the area mapping data, is applied, the first computer copies the control data of the owner volume to the second computer.”.

### CITATION LIST

### Patent Literature

PTL 1: JP2022-169249A

### SUMMARY OF THE INVENTION

In the related art, when a volume creating the asynchronous remote copy pair is migrated to another node, it is required to delete the pair. For example, when a node is removed, it is required to migrate a volume in a target node to another node. However, the volume that has created the asynchronous remote copy pair is migrated to another node after being unpaired once because a storage controller cannot transfer information between nodes. In addition, even in the case of capacity rebalance that operates during node addition, pair deletion is required to migrate the volume that has created the existing asynchronous remote copy pair to an addition node due to the same problem. In addition, the operation cost is high, and the fault tolerance is also low.

Accordingly, an object of the invention is to perform migration of a volume in a state of maintaining a pair.

In order to achieve the above object, one representative storage system according to the invention includes a plurality of nodes each including a processor. A first node includes a primary volume configured to provide a logical storage area to a host. A second node includes a secondary volume configured to create a remote copy pair with the primary volume and sets the remote copy using identification information on the primary volume and identification information on the secondary volume. A third node includes a migration destination volume to be a migration destination when migration is performed with the secondary volume as a migration source volume. The first node creates a new pair between the primary volume and the migration destination volume when receiving a new pair creating request in which the identification information on the primary volume, the identification information on the secondary volume, and information identifying the third node are designated. The second node deletes the pair of the secondary volume and the primary volume and replaces the identification information on the migration destination volume with the identification information on the secondary volume.

One representative storage system according to the invention includes a plurality of nodes each including a processor. A first node includes a primary volume configured to provide a logical storage area to a host. A second node includes a secondary volume configured to create a remote copy pair with the primary volume and sets the remote copy using identification information on the primary volume and identification information on the secondary volume. A third node includes a migration destination volume to be a migration destination when migration is performed with the primary volume as a migration source volume. The second node creates a new pair between the secondary volume and the migration destination volume when receiving a new pair creating request in which the identification information on the primary volume, the identification information on the secondary volume, and information identifying the third node are designated. The first node deletes the pair of the secondary volume and the primary volume and replaces the identification information on the migration destination volume with the identification information on the primary volume.

One representative method for managing the storage system according to the invention is a method for managing a storage system including a plurality of nodes each including a processor. The method includes: providing a primary volume configured to provide a logical storage area to a host in a first node; providing a secondary volume configured to create a remote copy pair with the primary volume in a second node and setting the remote copy using identification information on the primary volume and identification information on the secondary volume by the second node; providing a migration destination volume to be a migration destination when migration is performed with the secondary volume as a migration source volume in a third node; creating, by the first node, a new pair between the primary volume and the migration destination volume when receiving a new pair creating request in which the identification information on the primary volume, the identification information on the secondary volume, and information identifying the third node are designated; and deleting the pair of the secondary volume and the primary volume and replacing the identification information on the migration destination volume with the identification information on the secondary volume, by the second node.

One representative method for managing the storage system according to the invention is a method for managing a storage system including a plurality of nodes each including a processor. The method includes: providing a primary volume configured to provide a logical storage area to a host in a first node; providing a secondary volume configured to create a remote copy pair with the primary volume in a second node and setting the remote copy using identification information on the primary volume and identification information on the secondary volume by the second node; providing a migration destination volume to be a migration destination when migration is performed with the primary volume as a migration source volume in a third node; creating, by the second node, a new pair between the secondary volume and the migration destination volume when receiving a new pair creating request in which the identification information on the primary volume, the identification information on the secondary volume, and information identifying the third node are designated; and deleting the pair of the secondary volume and the primary volume and replacing the identification information on the migration destination volume with the identification information on the primary volume, by the first node.

According to the invention, a volume can be migrated in a state of maintaining a pair. The problems, configurations, and effects other than those described above will become apparent in the following description of embodiments.

### BRIEF DESCRIPTION OF THE DRAWINGS

FIG. 1 is an illustration diagram of migration in Embodiment 1;

FIG. 2 shows a hardware configuration of a storage system;

FIG. 3 is an illustration diagram of remote copy;

FIG. 4 is an illustration diagram of input/output processing;

FIG. 5 is a list of memory information;

FIG. 6 is a specific example of a system configuration management table;

FIG. 7 is a specific example of a pair management table;

FIG. 8 is a specific example of a journal management table;

FIG. 9 is a specific example of a migration configuration management table;

FIG. 10 is an illustration diagram of path creation processing;

FIG. 11 is an illustration diagram of remote copy processing (asynchronous transfer);

FIG. 12 is an illustration diagram of migration processing in Embodiment 1 (part 1);

FIG. 13 is an illustration diagram of the migration processing in Embodiment 1 (part 2);

FIG. 14 is an illustration diagram of migration in Embodiment 2;

FIG. 15 is an illustration diagram of migration processing in Embodiment 2 (part 1);

FIG. 16 is an illustration diagram of the migration processing in Embodiment 2 (part 2);

FIG. 17 is an illustration diagram of migration processing in Embodiment 3 (part 1); and

FIG. 18 is an illustration diagram of the migration processing in Embodiment 3 (part 2).

### DESCRIPTION OF EMBODIMENTS

Hereinafter, embodiments will be described with reference to the drawings.

### Embodiment 1

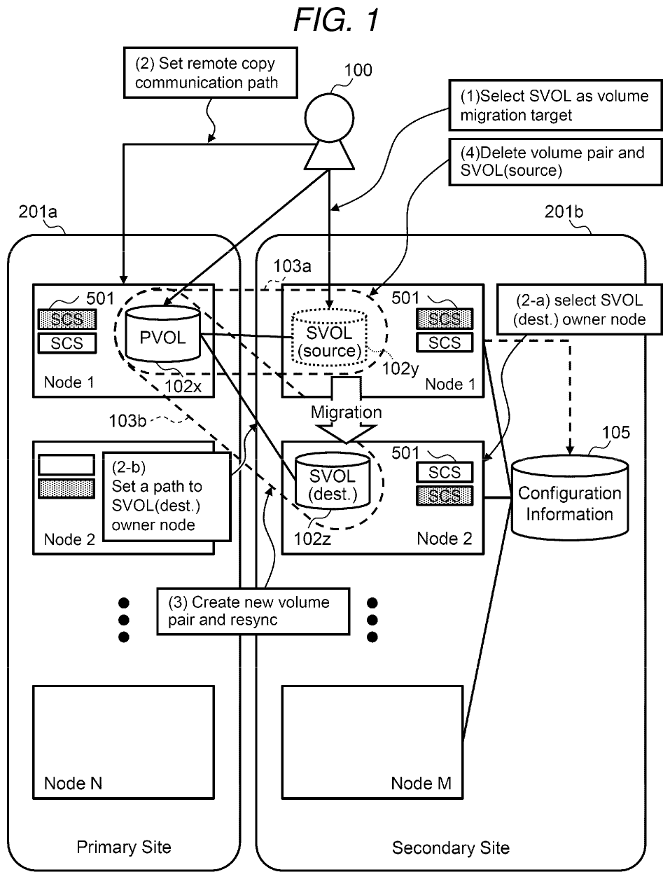

FIG. 1 is an illustration diagram of migration in Embodiment 1. A storage system of Embodiment 1 includes a primary site 201a and a secondary site 201b. Each of the primary site 201a and the secondary site 201b includes a plurality of nodes. The plurality of nodes each include a storage control system (SCS) 501. As an example, each node includes a plurality of SCS 501 for redundancy.

One of the nodes of the primary site 201a includes a primary volume (PVOL) 102x. One of the nodes of the secondary site 201b includes a secondary volume (SVOL) 102y. The primary volume 102x and the secondary volume 102y create a volume pair 103a.

A configuration of the storage system in the secondary site 201b is managed as configuration information 105.

Processing in a case where a user terminal 100 receives an operation from a user and migrates the secondary volume 102y to another node of the secondary site 201b will be described.

(1) In the user terminal 100, the secondary volume 102y as a migration target is selected. The selected secondary volume 102y is referred to as a migration source volume, a secondary volume as a migration source, or an SVOL (source). A node including a migration source volume is referred to as a migration source node.

(2) In the user terminal 100, a remote copy path is set. The processing includes (2-a) and (2-b).

(2-a) A node including a secondary volume 102z as a migration destination is selected. The secondary volume 102z as a migration destination is referred to as a migration destination volume, a migration destination secondary volume, or an SVOL (dest.). A node including a migration destination volume is referred to as a migration destination node.

(2-b) A path is set from the node including the primary volume 102x to the node including the migration destination secondary volume 102z.

(3) A new volume pair 103b is created with the primary volume 102x and the migration destination secondary volume 102z, and data is synchronized.

(4) The volume pair 103a of the primary volume 102x and the migration source secondary volume 102y is deleted.

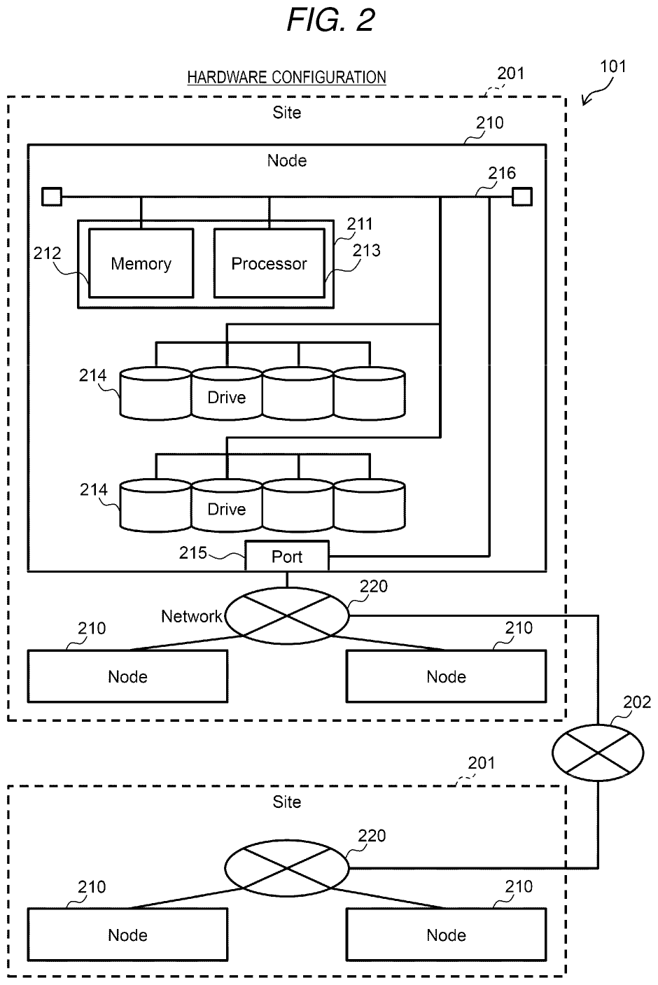

FIG. 2 shows a hardware configuration of the storage system. A plurality of sites 201 are connected via a network 202. Each of the sites 201 includes a plurality of nodes 210. The plurality of nodes 210 are communicably connected via a network 220 inside the site 201.

Each of the nodes 210 includes a configuration in which a control device 211, a plurality of drives 214 as storage devices, and a port 215 are connected by a bus 216.

The port 215 communicates with another node via the network 220.

The plurality of drives 214 include physical storage areas.

The control device 211 includes a processor 213 and a memory 212. The processor 213 operates as a storage control system (SCS) by loading a predetermined program into the memory 212 and executing the program. The storage control system (SCS) configures a volume, which is a logical storage area, from the physical storage area of the drives 214, and processes input/output to/from the volume.

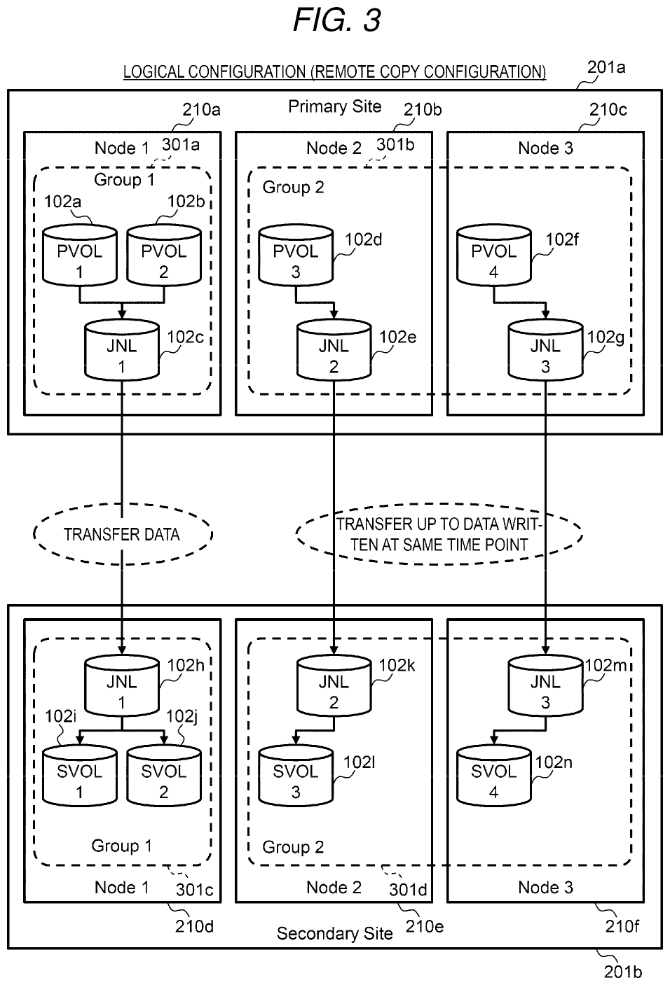

FIG. 3 is an illustration diagram of remote copy. In FIG. 3, the primary site 201a includes a node 210a, a node 210b, and a node 210c. The secondary site 201b includes a node 210d, a node 210e, and a node 210f.

The node 210a includes a primary volume 102a, a primary volume 102b, and a journal volume 102c.

The node 210d includes a journal volume 102h, a secondary volume 102i, and a secondary volume 102j.

The primary volume 102a, the primary volume 102b, the journal volume 102c, the journal volume 102h, the secondary volume 102i, and the secondary volume 102j belong to a group 1 whose consistency is managed.

Writing to the primary volume 102a and the primary volume 102b is accumulated in the journal volume 102c. The contents in the journal volume 102c are data-transferred to the journal volume 102h, and are reflected in the secondary volume 102l and the secondary volume 102j according to the time series, thereby implementing asynchronous remote copy in the group 1.

The node 210b includes a primary volume 102d and a journal volume 102e. The node 210c includes a primary volume 102f and a journal volume 102g.

The node 210e includes a journal volume 102k and a secondary volume 102l. The node 210f includes a journal volume 102m and a secondary volume 102n.

The primary volume 102d, the journal volume 102e, the primary volume 102f, the journal volume 102g, the journal volume 102k, the secondary volume 102l, the journal volume 102m, and the secondary volume 102n belong to a group 2 whose consistency is managed.

Writing to the primary volume 102d is accumulated in the journal volume 102e. Writing to the primary volume 102f is accumulated in the journal volume 102g. The contents in the journal volume 102e and the journal volume 102g are transferred up to the data written at the same time point. The data in the journal volume 102e is transferred to the journal volume 102k and then reflected in the secondary volume 102l. The data in the journal volume 102g is transferred to the journal volume 102m and then reflected in the secondary volume 102n. As a result, asynchronous remote copy of the group 2 can be implemented.

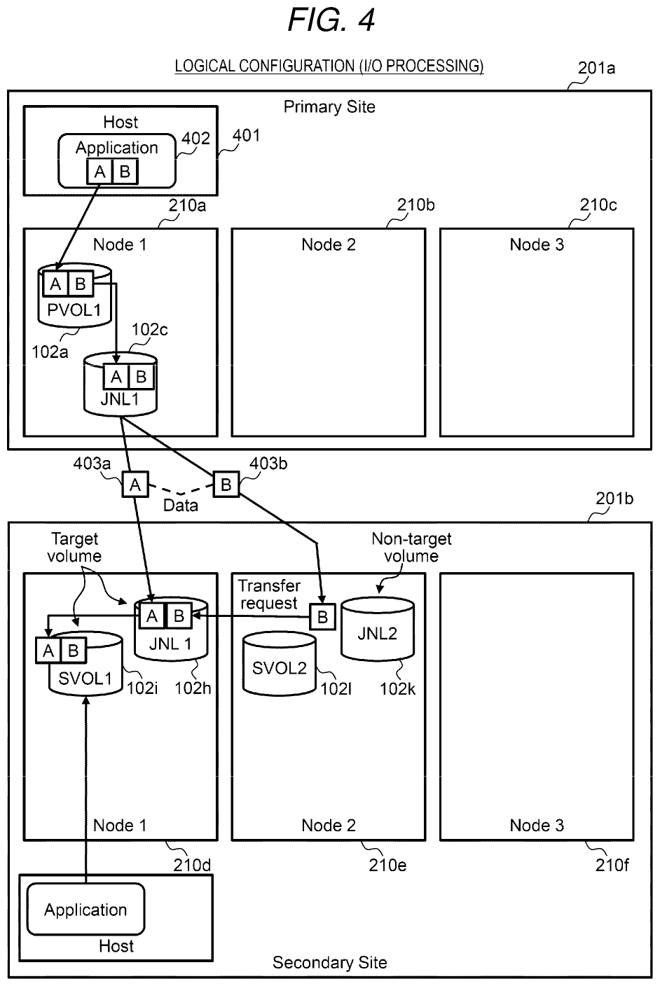

FIG. 4 is an illustration diagram of input/output processing. A case where a host 401 of the primary site 201a performs writing will be described. An application 402 of the host 401 writes data “A” and “B” to the primary volume 102a. The node 210a including the primary volume 102a accumulates a history of writing to the primary volume 102a in the journal volume 102c.

The data “A” and “B” accumulated in the journal volume 102c are transferred to the secondary site 201b. In the example of FIG. 4, data 403a, which is a writing history of the data “A”, is directly sent to the node 210d and stored in the journal volume 102h. Data 403b, which is a writing history of the data “B”, is sent to the node 210d via the node 210e and stored in the journal volume 102h. Thereafter, the writing of the data “A” and the writing of the data “B” are reflected in the secondary volume 102i. As a result, the contents of the secondary volume 102i match the contents of the primary volume 102a.

Note that a host of the secondary site 201b can read data from the secondary volume 102l.

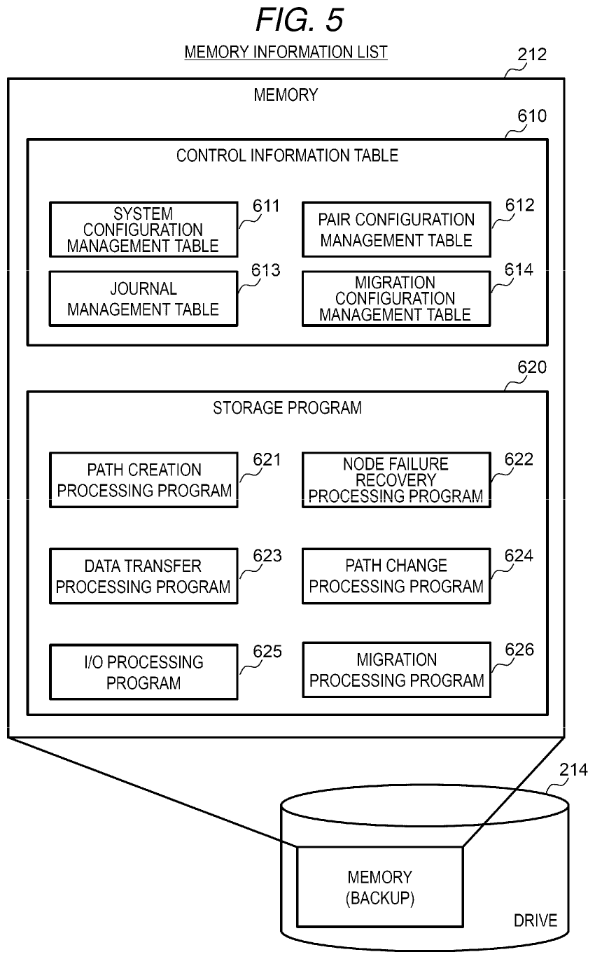

FIG. 5 is a list of memory information. The information stored in the memory 212 includes a control information table 610 and a storage program 620.

The control information table 610 includes a system configuration management table 611, a pair configuration management table 612, a journal management table 613, and a migration configuration management table 614.

The storage program 620 includes a path creation processing program 621, a node failure recovery processing program 622, a data transfer processing program 623, a path change processing program 624, an I/O processing program 625, and a migration processing program 626. The processor 213 implements functions as a storage control system (SCS) by executing various programs in the storage program 620.

These pieces of memory information can be backed up in a storage area of the drive 214.

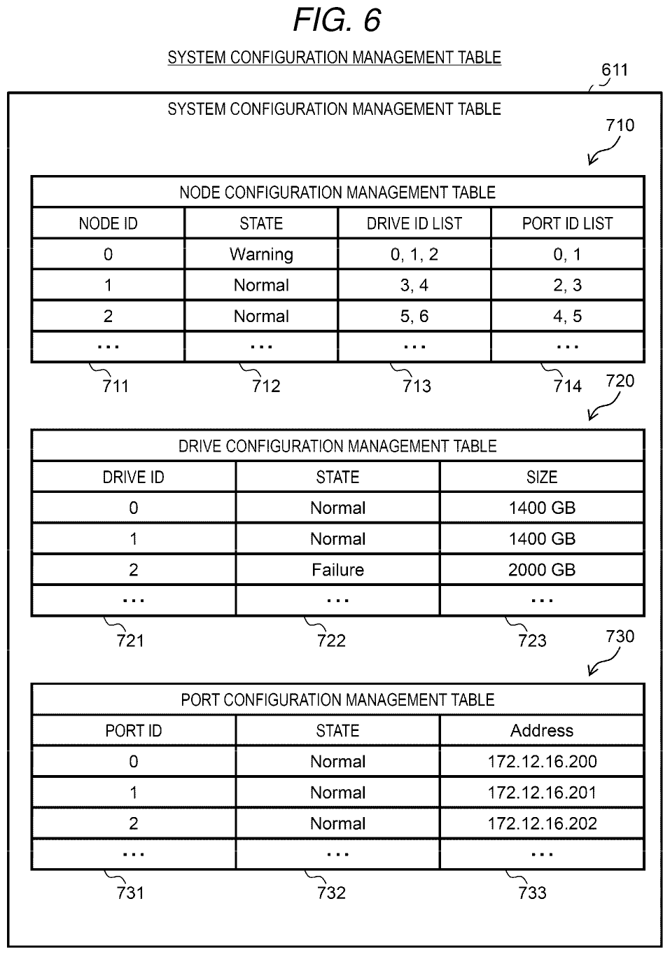

FIG. 6 shows a specific example of the system configuration management table 611. The system configuration management table 611 includes a node configuration management table 710, a drive configuration management table 720, and a port configuration management table 730.

The node configuration management table 710 includes items, i.e., a node ID 711, a node state 712, a drive ID list 713 indicating a drive of a node, and a port ID list 714 indicating a port of a node.

The drive configuration management table 720 includes items, i.e., a drive ID 721, a drive state 722, and a drive size 723.

The port configuration management table 730 includes items, i.e., a port ID 731, a port state 732, and a port address 733.

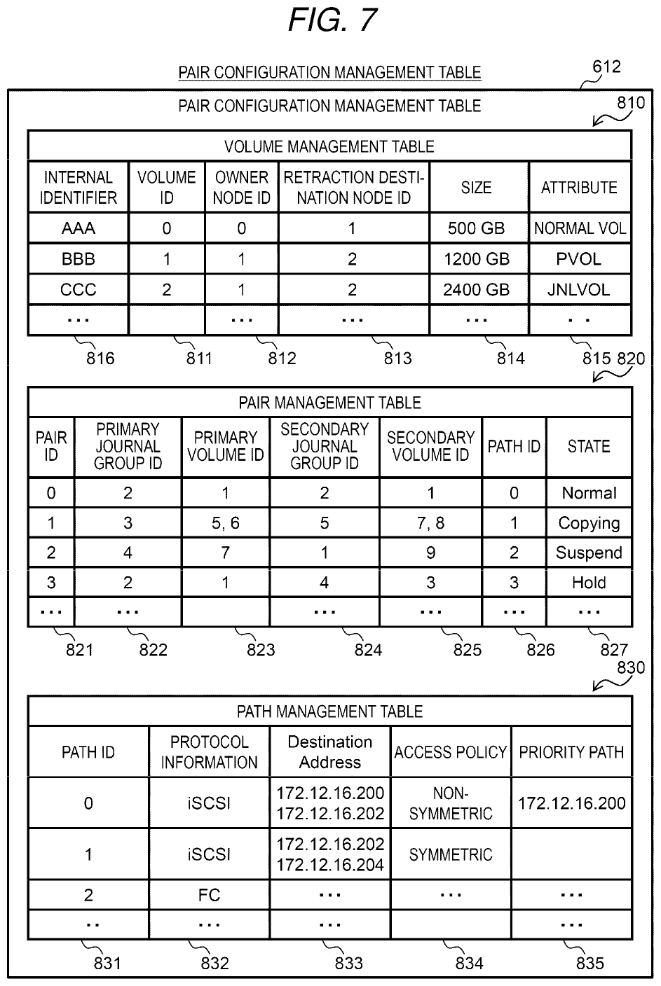

FIG. 7 shows a specific example of the pair configuration management table 612. The pair configuration management table 612 includes a volume management table 810, a pair management table 820, and a path management table 830.

The volume management table 810 includes items, i.e., a volume ID, an owner node ID 812, a retraction destination node ID 813, a size 814, an attribute 815, and an internal identifier 816. In the attribute 815, values of normal VOL, PVOL, SVOL, JNLVOL (journal volume), and the like are taken.

The pair management table 820 includes items, i.e., a pair ID 821, a primary journal group ID 822, a primary volume ID 823, a secondary journal group ID 824, a secondary volume ID 825, a path ID 826, and a state 827.

The path management table 830 includes items, i.e., a path ID 831, a protocol information 832, a destination address 833, an access policy 834, and a priority path 835.

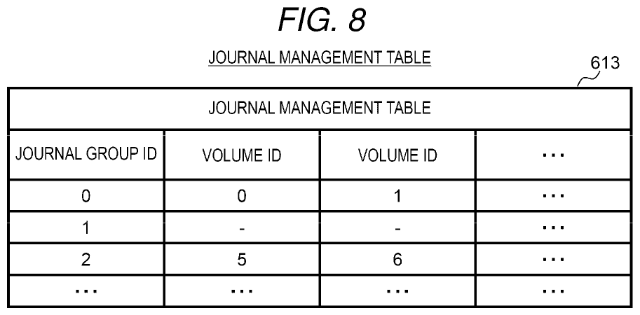

FIG. 8 shows a specific example of the journal management table 613. The journal management table 613 includes a journal group ID and a volume ID of a volume managed by the journal group.

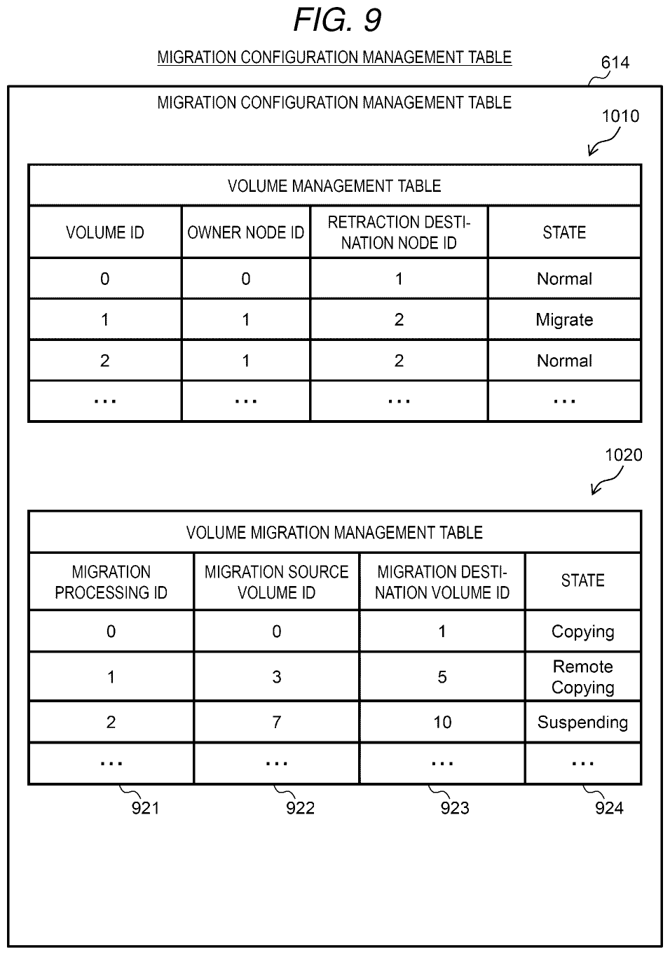

FIG. 9 shows a specific example of the migration configuration management table 614. The migration configuration management table 614 includes a volume management table 1010 and a volume migration management table 1020.

The volume management table 1010 includes items, i.e., a volume ID, an owner node ID, a retraction destination node ID, and a state.

The volume migration management table 1020 includes items, i.e., a migration processing ID 921, a migration source volume ID 922, a migration destination volume ID 923, and a state 924.

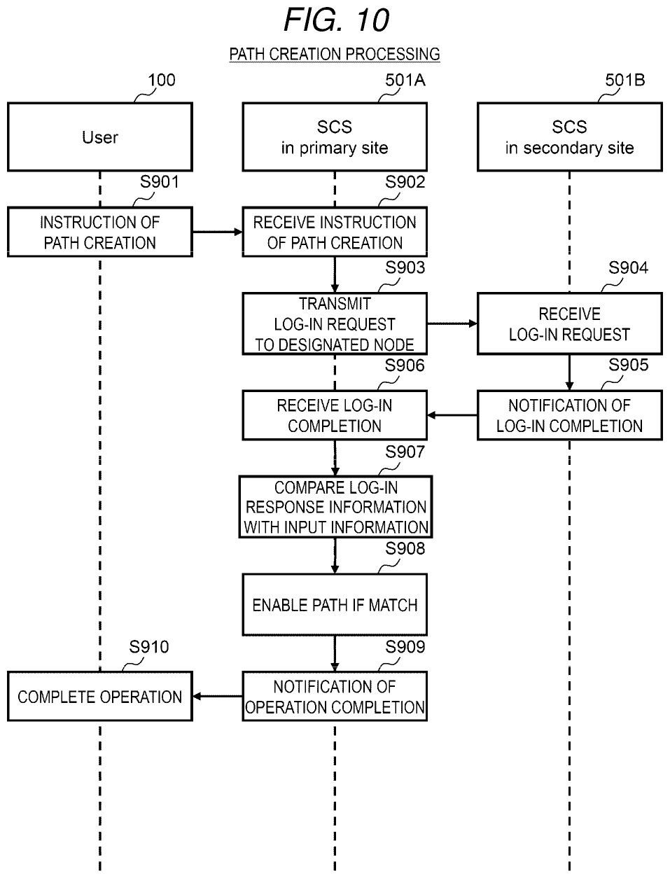

FIG. 10 is an illustration diagram of path creation processing. In the path creation processing, first, the user terminal 100 instructs an SCS 501A in the primary site to create a path (step S901).

The SCS 501A receives the instruction of the path creation (step S902) and transmits a log-in request to the specified node (step S903).

An SCS 501B in the secondary site receives the log-in request (step S904). Thereafter, the SCS 501B notifies the SCS 501A of completion of log-in (step S905).

When receiving the completion of log-in (step S906), the SCS 501A compares log-in response information with input information (step S907). If the log-in response information matches the input information, the SCS 501A validates the path (step S908) and notifies the user terminal 100 of completion of operation (step S909).

When the user terminal 100 receives the notification of the operation of completion (step S910), the path creation processing ends.

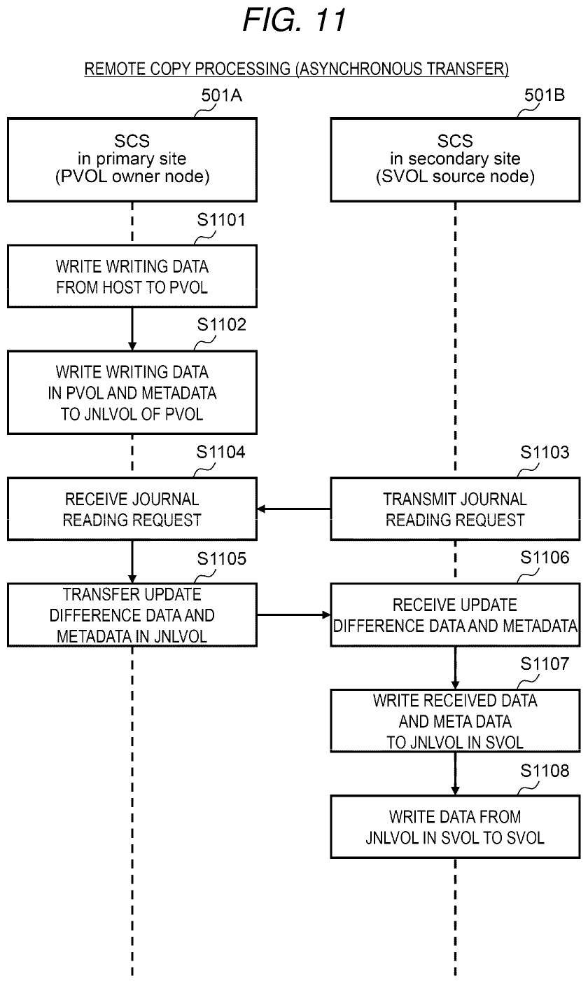

FIG. 11 is an illustration diagram of remote copy processing (asynchronous transfer).

The SCS 501A in a primary volume owner node writes writing data from a host to the primary volume (step S1101). Thereafter, the writing data in the primary volume and metadata are written to a journal volume of the primary volume (step S1102).

The SCS 501B in a migration source node including a secondary volume as a migration source (SVOL source node) transmits a journal reading request to the SCS 501A (step S1103).

The SCS 501A receives the journal reading request (step S1104) and transfers update difference data and the metadata in the journal volume (step S1105).

The SCS 501B receives the update difference data and the metadata (step S1106), and writes the received data and metadata to a journal volume of the secondary volume (step S1107). Thereafter, the SCS 501B writes the data from the journal volume of the secondary volume to the secondary volume (step S1108).

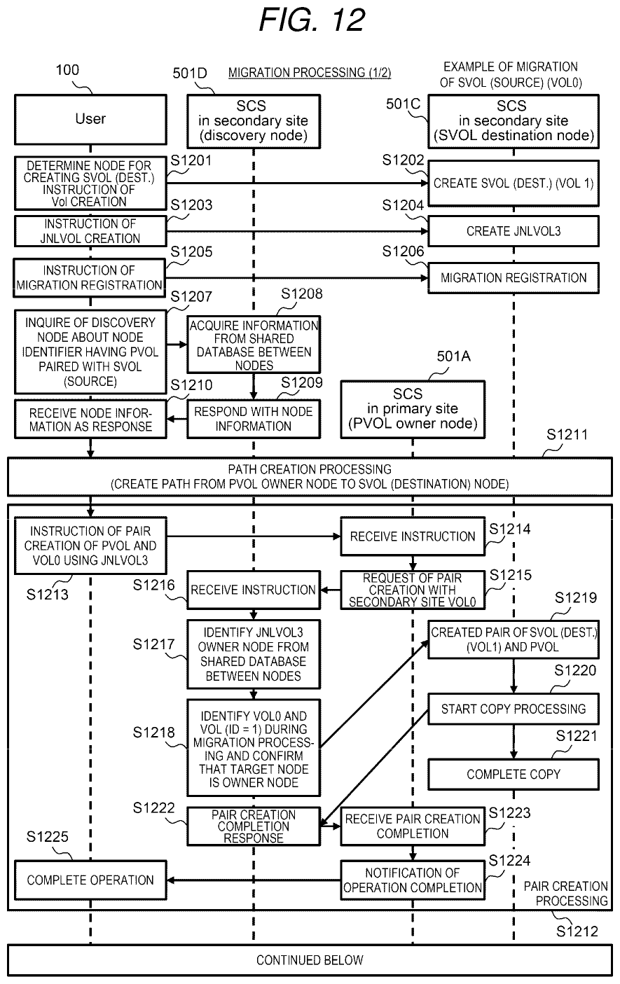

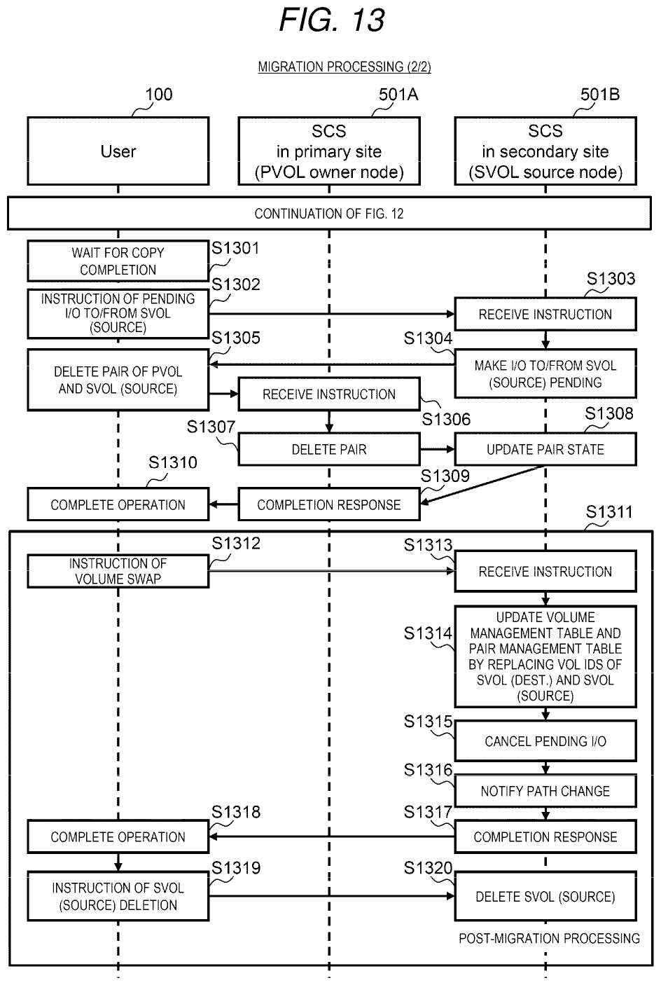

FIGS. 12 and 13 are illustration diagrams of migration processing in Embodiment 1. The user terminal 100, the SCS 501A, the SCS 501B, an SCS 501C, and an SCS 501D are involved in the migration processing.

The SCS 501A is an SCS in a primary volume owner node.

The SCS 501B is an SCS in a migration source node including a secondary volume as a migration source (SVOL source node).

The SCS 501C is an SCS in a migration destination node including a secondary volume as a migration destination (SVOL destination node).

The SCS 501D is an SCS in a representative node (discovery node) that centrally manages a configuration of a secondary site.

First, the user terminal 100 determines a migration destination node and instructs creation of a volume (step S1201). An SCS in a node receiving the instruction is the SCS 501C. The SCS 501C creates a secondary volume as a migration destination (step S1202). Identification information on the volume is defined as Vol1.

The user terminal 100 instructs the SCS 501C to create a journal volume (step S1203). The SCS 501C receives the instruction and creates the journal volume (step S1204). Identification information on the volume is defined as JNLVol3.

Next, the user terminal 100 performs migration registration using VOLO, which is a migration target, as a migration source volume ID and the created Vol1 as a migration destination volume ID (step S1205). The migration registration is performed by registering the Vol ID pair information in the volume migration management table 1020 (step S1206). In addition, the migration processing is a migration in a state where a remote copy pair is maintained, and therefore, the migration processing is managed by giving a state called “Remote Copying” in order to distinguish another migration.

The user terminal 100 inquires of the SCS 501D about an identifier of a node including a primary volume paired with the migration source secondary volume (step S1207).

The SCS 501D acquires the information from a shared database between the nodes (step S1208) and responds to the user terminal 100 with the information on the node (step S1209).

The user terminal 100 receives the information on the node as a response (step S1210), and performs path creation processing (step S1211). The path creation processing is processing for creating a path from the primary volume owner node to the migration destination node.

Thereafter, the system performs pair creation processing (step S1212). Specifically, first, the user terminal 100 instructs the SCS 501A to create a pair using the primary volume, Vol0, and JNLVol3 (step S1213). Here, Vol0 is identification information on the secondary volume as the migration source.

When receiving the instruction (step S1214), the SCS 501A requests the representative node SCS501D to create a pair with Vol0 (step S1215).

When receiving the instruction (step S1216), the representative node SCS501D identifies a JNLVol3 owner node (that is, a migration destination node) from the shared database between the nodes (step S1217). Then, Vol1 in the target node and Vol1 during the migration processing (i.e., migration destination secondary volume) are identified using the volume migration management table 1020 (step S1218). That is, the migration source volume ID 922 column is searched using Vol0 as a key, and the migration destination volume ID 923 corresponding to the matched row is set as Vol ID during the migration processing.

Next, the Vol ID during the migration processing is compared with the JNLVOl owner node, and an error is returned as an operation error if the Vol ID during the migration processing does not match the JNLVOl owner node. The node having the Vol ID during the migration processing is identified by referring to the volume management table 1010. The JNLVOl owner node identifies the volume ID by referring to the journal management table 613, and identifies an owner node ID corresponding to the volume ID by referring to the volume management table 1010. If the two match each other, the processing proceeds.

The SCS 501C in the identified migration destination node creates a pair of Vol1, which is the migration destination secondary volume, and the primary volume (step S1219).

The SCS 501C starts copy processing from the primary volume to the Vol1 (step S1220), and completes the copy (step S1221).

After the SCS 501C starts copy, the SCS 501D transmits a response of the pair creation completion to the SCS 501A (step S1222). When the SCS 501A receives the response of the pair creation completion (step S1223), the SCS 501A notifies the user terminal 100 of completion of the operation (step S1224). The user terminal 100 receives the notification and completes the operation (step S1225).

In this way, in the pair creation processing according to the present embodiment, the user terminal 100 designates the identification information on the migration source secondary volume (Vol0) and the identification information on the journal volume (JNLVol3) corresponding to the migration destination secondary volume, and instructs creation of a new pair. The SCS 501A in the node including the primary volume (PVol) does not directly create a pair using the identification information on the designated secondary volume (Vol0), but identifies the node by making an inquiry to the SCS 501D in the representative node based on JNLVol3, and sets Vol1, for which migration is performed with Vol0 in the node, as the migration destination. In this way, a pair is created with the migration destination secondary volume by replacing Vol0 with Vol1.

After the pair creation processing shown in FIG. 12, as shown in FIG. 13, the user terminal 100 waits for completion of copying in the SCS 501B (step S1301). After the copy is completed, the user terminal 100 instructs the SCS 501B in the migration source node of pending input/output to/from the migration source secondary volume (step S1302).

The SCS 501B receives the instruction from the user terminal 100 (step S1303) and makes the input/output to/from the migration source secondary volume pending (step S1304).

Thereafter, the user terminal 100 instructs the SCS 501A to delete the pair (old pair) of the primary volume and the migration source secondary volume (step S1305).

The SCS 501A receives the instruction from the user terminal 100 (step S1306) and deletes the pair (step S1307).

The SCS 501B receives the deletion of the pair and updates a pair state (step S1308).

After deleting the pair, the SCS 501A transmits a completion response to the user terminal 100 (step S1309), and the user terminal 100 completes the operation (step S1310). Thereafter, post-migration processing is performed (step S1311).

In the post-migration processing, the user terminal 100 transmits a volume swap instruction to the SCS 501B (step S1312). When receiving the instruction (step S1313), the SCS 501B updates the volume ID in the volume management table by replacing a value of an ID of a migration destination secondary volume (Vol1 in this example) with a value of an ID of a migration source secondary volume (Vol0 in this example).

In addition, the secondary volume ID in the pair management table is updated by rewriting the value of an ID of a migration destination secondary volume (Vol1 in this example) to an ID of a migration source secondary volume (Vol0 in this example) (step S1314).

Thereafter, the entry related to the migration processing registered in the present processing is deleted from the volume migration management table.

Thereafter, the pending input/output is canceled (step S1315), a path change is notified (step S1316), and a completion response is transmitted to the user terminal 100 (step S1317).

The user terminal 100 receives the completion response and completes the operation (step S1318), and instructs the SCS 501B to delete the migration source secondary volume (step S1319).

The SCS 501B receives the instruction from the user terminal 100, deletes the migration source secondary volume (step S1320), and ends the post-migration processing.

In this way, when a pair is created with the migration destination volume, the replacement is performed using identification information on the journal volume as the migration destination to create the pair with the migration destination secondary volume, and then, the identification information on the migration source secondary volume rewritten is to the identification information on the migration destination secondary volume. Therefore, migration of the secondary volume can be performed while the primary volume creates a pair with the identification information on the same secondary volume.

The above description shows a procedure of executing a series of processing by the user terminal 100 after receiving an operation from the user, and instead of the user terminal, the SCS 501 may perform the processing.

### Embodiment 2

In Embodiment 2, a configuration for copying data from a migration source secondary volume to a migration destination secondary volume will be described.

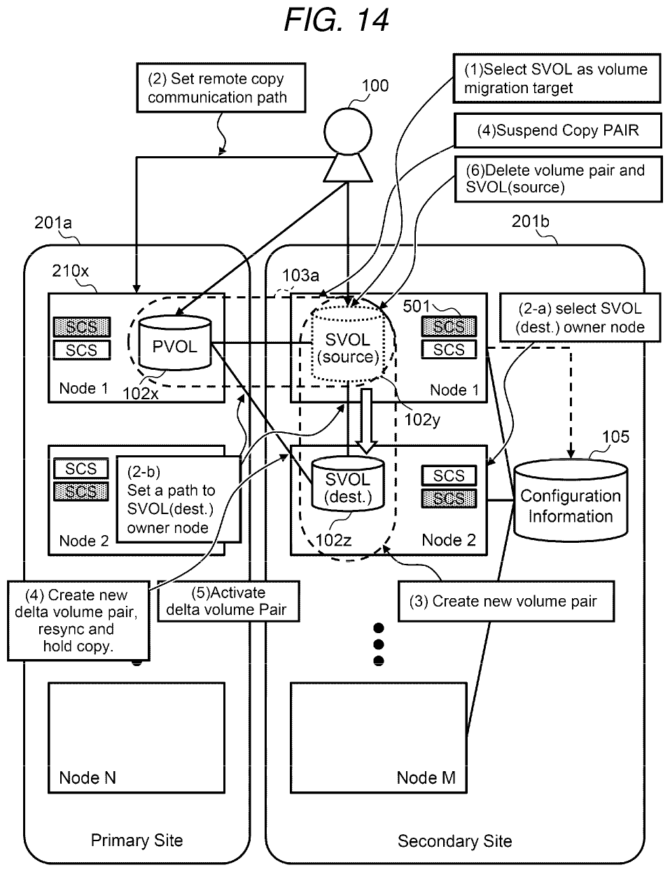

FIG. 14 is an illustration diagram of migration in Embodiment 2. A storage system according to Embodiment 2 includes the primary site 201a and the secondary site 201b. Each of the primary site 201a and the secondary site 201b includes a plurality of nodes. The plurality of nodes each include the storage control system (SCS) 501. As an example, each node includes a plurality of SCSs 501 for redundancy.

One of the nodes of the primary site 201a includes the primary volume (PVOL) 102x. One of the nodes of the secondary site 201b includes the secondary volume (SVOL) 102y. The primary volume 102x and the secondary volume 102y create the volume pair 103a.

The configuration of the storage system in the secondary site 201b is managed as the configuration information 105.

Processing in a case where the user terminal 100 receives an operation from a user and migrates the secondary volume 102y to another node of the secondary site 201b will be described.

(1) In the user terminal 100, the secondary volume 102y as a migration target is selected. The selected secondary volume 102y is referred to as a migration source volume, a migration source secondary volume, or an SVOL (source). A node including a migration source volume is referred to as a migration source node.

(2) In the user terminal 100, a remote copy path is set. The processing includes (2-a) and (2-b).

(2-a) A node including the secondary volume 102z as a migration destination is selected. The secondary volume 102z as a migration destination is referred to as a migration destination volume, a migration destination secondary volume, or an SVOL (dest.). A node including a migration destination volume is referred to as a migration destination node.

(2-b) A path is set from a node including the primary volume 102x to a migration destination node including the migration destination secondary volume 102z. Further, a path from the migration source node to the migration destination node is set.

(3) A new volume pair is created by the migration source secondary volume 102y and the migration destination secondary volume 102z, and data is synchronized.

(4) The new volume pair 103b is created by the primary volume 102x and the migration destination secondary volume 102z, but data is held without being copied.

(5) Delta volume paths of the primary volume 102x, the migration source secondary volume 102y, and the migration destination secondary volume 102z are activated.

(6) The volume pair 103a of the primary volume 102x and the migration source secondary volume 102y is deleted, and the migration source secondary volume is deleted.

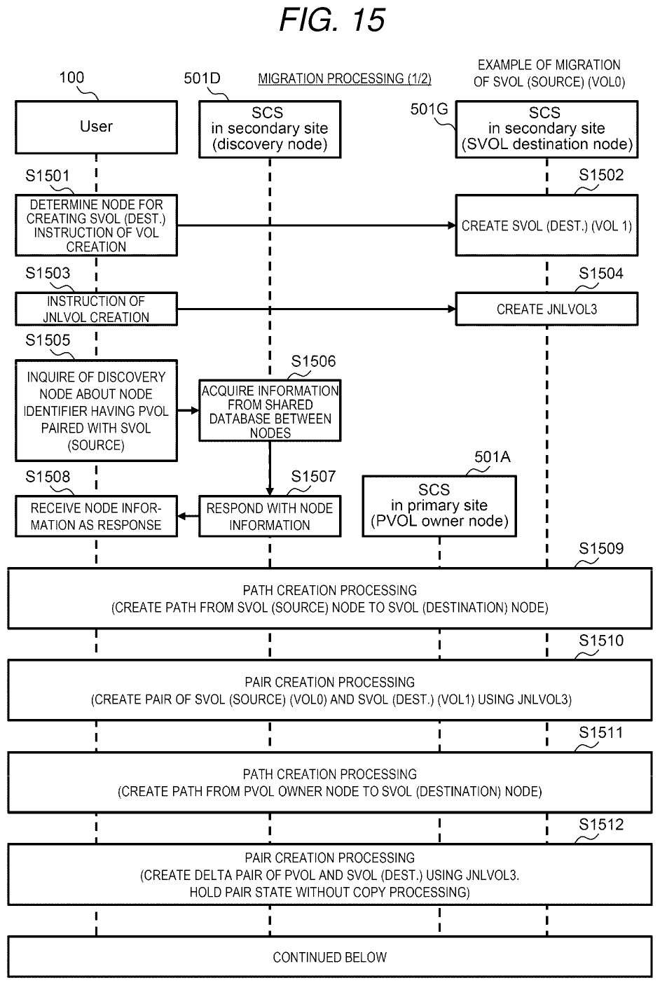

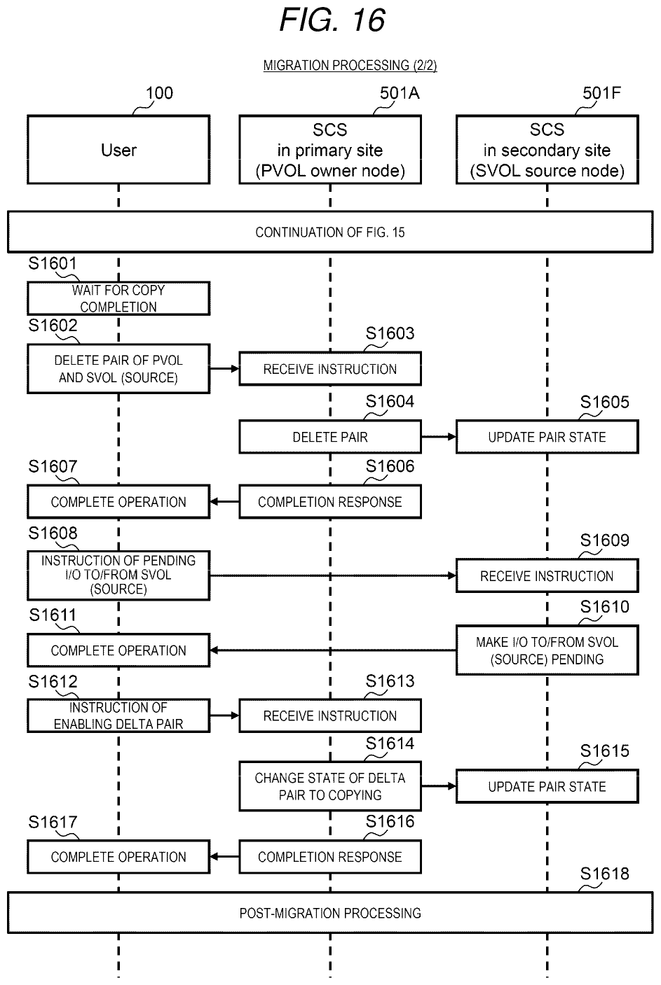

FIGS. 15 and 16 are illustration diagrams of migration processing in Embodiment 2. The user terminal 100, the SCS 501A, an SCS 501F, an SCS 501G, and the SCS 501D are involved in the migration processing.

The SCS 501A is an SCS in a primary volume owner node.

The SCS 501F is an SCS in a migration source node including a secondary volume as a migration source (SVOL source node).

The SCS 501G is an SCS in a migration destination node including a secondary volume as a migration destination (SVOL destination node).

The SCS 501D is an SCS in a representative node (discovery node) that centrally manages a configuration of a secondary site.

First, the user terminal 100 determines a migration destination node and instructs creation of a volume (step S1501). An SCS in a node receiving the instruction is the SCS 501G. The SCS 501G creates a secondary volume as a migration destination (step S1502). Identification information on the volume is defined as Vol1.

The user terminal 100 instructs the SCS 501G to create a journal volume (step S1503). The SCS 501G receives the instruction and creates the journal volume (step S1504). Identification information on the volume is defined as JNLVol3.

The user terminal 100 inquires of the SCS 501D about an identifier of a node including a primary volume paired with the migration source secondary volume (step S1505).

The SCS 501D acquires the information from a shared database between the nodes (step S1506) and responds to the user terminal 100 with the information on the node (step S1507).

The user terminal 100 receives the node information as a response (step S1508), and performs path creation processing of creating a path from the migration source node to the migration destination node (step S1509). Thereafter, the migration source secondary volume (Vol0) and the migration destination secondary volume (Vol1) create a pair using JNLVol3 (step S1510).

The pair creation using JNLVol3 is processing of creating a pair with the migration destination secondary volume by replacing Vol0 with Vol1 by designating the identification information (Vol0) on the migration source secondary volume and the identification information (JNLVol3) on the journal volume corresponding to the migration destination secondary volume, instructing the creation of a new pair, and inquiring the SCS 501D in the representative node based on JNLVol3.

After the pair of the migration source secondary volume (Vol0) and the migration destination secondary volume (Vol1) is created, path creation processing of creating a path from the primary volume owner node to the migration destination node is performed (step S1511). Thereafter, the primary volume and the migration destination secondary volume (Vol1) create a pair using JNLVol3 (step S1512). As a result, a delta pair of the primary volume, the migration source secondary volume (Vol0), and the migration destination secondary volume (Vol1) is created. A state is held in which processing of copying data from the secondary volume to the migration destination primary volume (Vol1) is not performed.

After creating the delta pair shown in FIG. 15, as shown in FIG. 16, the user terminal 100 waits for completion of data copy from the migration source secondary volume (Vol0) to the migration destination secondary volume (Vol1) (step S1601). After the copy is completed, the user terminal 100 instructs the SCS 501A to delete the pair (old pair) of the primary volume and the migration source secondary volume (step S1602).

The SCS 501A receives the instruction from the user terminal 100 (step S1603) and deletes the pair (step S1604).

In response to the deletion of the pair, the SCS 501F updates the pair state (step S1605).

After the deletion of the pair, the SCS 501A transmits a completion response to the user terminal 100 (step S1606), and the user terminal 100 completes the operation (step S1607).

The user terminal 100 instructs the SCS 501F in the migration source node to make input/output to/from the migration source secondary volume pending (step S1608).

The SCS 501F receives the instruction from the user terminal 100 (step S1609) and makes the input/output to/from the migration source secondary volume pending (step S1610), and the user terminal 100 completes the operation (step S1611).

The user terminal 100 instructs the SCS 501A to enable the delta pair (step S1612).

The SCS 501A receives the instruction from the user terminal 100 (step S1613) and changes the state of the delta pair to copying (step S1614).

The SCS 501F updates the pair state (step S1615).

After the deletion of the pair, the SCS 501A transmits a completion response to the user terminal 100 (step S1616), and the user terminal 100 completes the operation (step S1617).

Thereafter, post-migration processing is performed (step S1618). The post-migration processing is the same as that of Embodiment 1, and detailed description thereof will be omitted. The post-migration processing includes replacement of the identification information on the migration source secondary volume and the identification information on the migration destination secondary volume.

In this way, when a pair is created with the migration destination volume, replacement is performed using the identification information on the journal volume as the migration destination to create the pair with the migration destination secondary volume, and then, the identification information on the migration source secondary volume is rewritten the to identification information on the migration destination secondary volume. Therefore, migration of the secondary volume can be performed while the primary volume creates a pair with the identification information on the same secondary volume.

Data is copied from the migration source secondary volume to the migration destination secondary volume, and therefore, the data copy is completed in the secondary site, and the amount of communication between the primary site and the secondary site can be reduced.

### Embodiment 3

In Embodiment 3, processing of migrating a primary volume to another node in a primary site will be described.

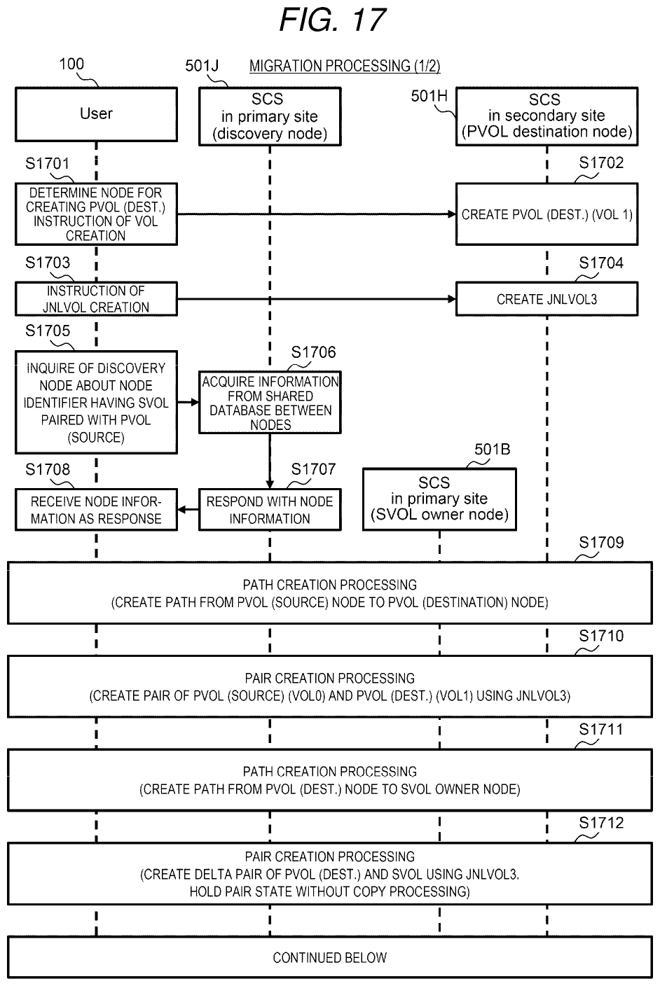

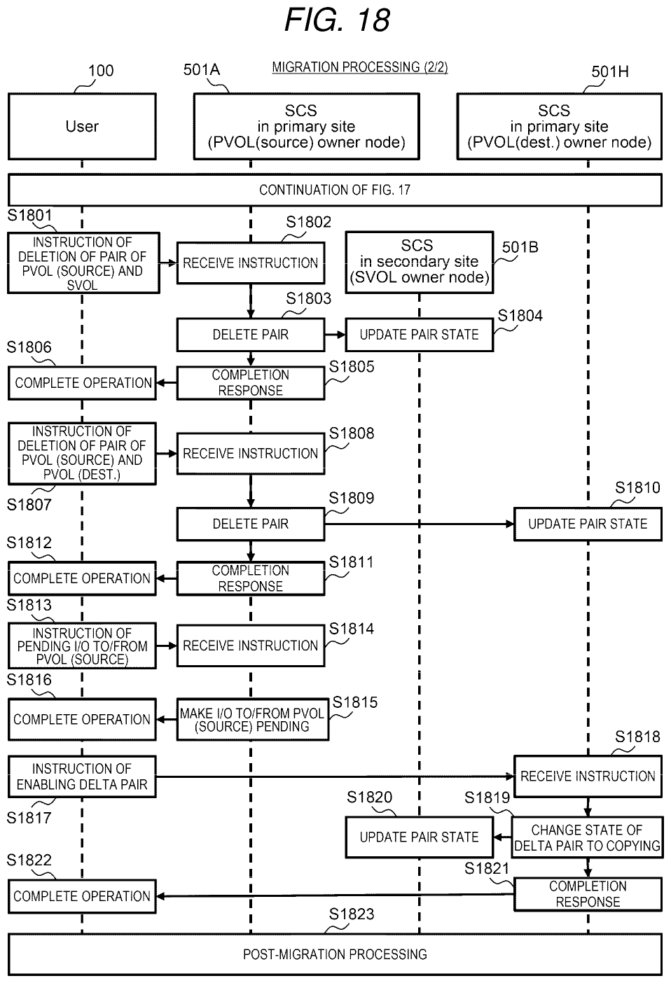

FIGS. 17 and 18 are illustration diagrams of migration processing in Embodiment 3. The user terminal 100, the SCS 501A, the SCS 501B, an SCS 501H, and an SCS 501J are involved in the migration processing.

The SCS 501A is an SCS in a migration source node including a primary volume as a migration source PVol (source).

The SCS 501B is an SCS in a secondary volume (SVOL) owner node.

The SCS 501H is an SCS in a migration destination node including a primary volume as a migration destination PVol (dest.).

The SCS 501J is an SCS in a representative node (discovery node) that centrally manages a configuration of a primary site.

First, the user terminal 100 determines a migration destination node and instructs creation of a volume (step S1701). An SCS in a node receiving the instruction is the SCS 501H. The SCS 501H creates a primary volume as the migration destination PVol (dest.) (step S1702). Identification information on the volume is defined as Vol1.

The user terminal 100 instructs the SCS 501H to create a journal volume (step S1703). The SCS 501H receives the instruction and creates the journal volume (step S1704). Identification information on the volume is defined as JNLVol3.

The user terminal 100 inquires of the SCS 501J about an identifier of a node including a secondary volume paired with the migration source primary volume (step S1705).

The SCS 501J acquires the information from a shared database between the nodes (step S1706), and responds to the user terminal 100 with the information on the node (step S1707).

The user terminal 100 receives the node information as a response (step S1708), and performs path creation processing of creating a path from the migration source node to the migration destination node (step S1709). Thereafter, the migration source primary volume PVol (source) (Vol0) and the migration destination primary volume PVol (dest.) (Vol1) create a pair using JNLVOl3 (step S1710).

The pair creation using JNLVol3 is processing of creating a pair with the migration destination primary volume by replacing Vol1 with Vol1 by designating the identification information (Vol0) on the migration source primary volume and the identification information (JNLVol3) on the journal volume corresponding to the migration destination primary volume, instructing the creation of a new pair, and inquiring the SCS 501J in the representative node based on JNLVol3.

After creating the pair of the migration source primary volume PVol (source) (Vol0) and the migration destination primary volume PVol (dest.), path creation processing of creating a path from the migration destination node to the secondary volume owner node s performed (step S1711). Thereafter, the migration destination primary volume PVol (dest.) and the secondary volume create a pair using JNLVol3 (step S1712). As a result, a delta pair of the migration source primary volume (Vol0), the secondary volume, and the migration destination primary volume (Vol1) is created. A state is held in which processing of copying data from the secondary volume to the migration destination primary volume (Vol1) is not performed.

After creating the delta pair shown in FIG. 17, as shown in FIG. 18, the user terminal 100 gives an instruction of deletion of the pair (old pair) of the migration source primary volume PVol (source) (Vol0) and the secondary volume (step S1801).

The SCS 501A receives the instruction from the user terminal 100 (step S1802) and deletes the pair (step S1803).

In response to the deletion of the pair, the SCS 501B updates the pair state (step S1804).

After the deletion of the pair, the SCS 501A transmits a completion response to the user terminal 100 (step S1805), and the user terminal 100 completes the operation (step S1806).

The user terminal 100 gives an instruction of deletion of the pair of the migration source primary volume PVol (source) (Vol0) and the migration destination primary volume PVol (dest.) (Vol1) (step S1807).

The SCS 501A receives the instruction from the user terminal 100 (step S1808), and deletes the pair (step S1809).

In response to the deletion of the pair, the SCS 501H updates the pair state (step S1810).

After the deletion of the pair, the SCS 501A transmits a completion response to the user terminal 100 (step S1811), and the user terminal 100 completes the operation (step S1812).

The user terminal 100 instructs the SCS 501A in the migration source node to make input/output to/from the migration source primary volume PVol (source) pending (step S1813).

The SCS 501A receives the instruction from the user terminal 100 (step S1814), and makes the input/output to/from the migration source primary volume PVol (source) pending (step S1815), and the user terminal 100 completes the operation (step S1816).

The user terminal 100 instructs the SCS 501H to enable the delta pair (step S1817).

The SCS 501H receives the instruction from the user terminal 100 (step S1818) and changes a state of the delta pair to copying (step S1819).

The SCS 501B updates the pair state (step S1820).

The SCS 501H transmits a completion response to the user terminal 100 (step S1821), and the user terminal 100 completes the operation (step S1822).

Thereafter, post-migration processing is performed (step S1823). The post-migration processing is the same as that of Embodiment 1, and detailed description thereof is omitted. The post-migration processing includes replacement of the identification information on the migration source primary volume and the identification information on the migration destination primary volume.

In this way, when a pair is created with the migration destination volume, replacement is performed using the identification information on the journal volume as the migration destination to create the pair with the migration destination primary volume, and then, the identification information on the migration source primary volume is rewritten to the identification information on the migration destination primary volume. Therefore, migration of the primary volume can be performed while the secondary volume creates a pair with the identification information on the same primary volume.

As described above, the disclosed system includes a plurality of nodes 210 each including the processor 213. The first node includes a primary volume configured to provide a logical storage area to the host 401. The second node includes a secondary volume configured to create a remote copy pair with the primary volume and sets the remote copy using identification information on the primary volume and identification information on the secondary volume. The third node includes a migration destination volume to be a migration destination when migration is performed with the secondary volume as a migration source volume. The first node creates a new pair between the primary volume and the migration destination volume when receiving a new pair creating request in which the identification information on the primary volume, the identification information on the secondary volume, and information identifying the third node are designated. The second node deletes the pair of the secondary volume and the primary volume and replaces the identification information on the migration destination volume with the identification information on the secondary volume.

Therefore, migration of the secondary volume can be performed in a state of maintaining the pair.

As an example, after input/output to/from the secondary volume is made pending, the second node deletes the pair of the secondary volume and the primary volume, replaces the identification information on the migration destination volume with the identification information on the secondary volume, and cancels the pending.

Therefore, migration can be performed without changing the identification information on the volume related to the remote copy setting and without affecting the content in the volume.

As an example, the first node further includes a first journal volume configured to accumulate a history of writing to the primary volume. The third node further includes a third journal volume corresponding to the first journal volume after the migration. Identification information on the third journal volume is used as information identifying the third node.

In this way, by using the identification information on the journal volume, a pair with the migration destination volume can be created without changing the identification information on the volume related to the remote copy setting.

As an example, the third node acquires a content in the primary volume from the first node and copies the content to the migration destination volume after the new pair is created. The second node deletes the pair of the secondary volume and the primary volume and replaces the identification information on the migration destination volume with the identification information on the secondary volume after the copy is completed.

In this configuration and operation, migration of the secondary volume can be performed by simple processing.

As an example, the third node acquires a content in the secondary volume from the second node and copies the content to the migration destination volume after the new pair is created. The second node deletes the pair of the secondary volume and the primary volume and replaces the identification information on the migration destination volume with the identification information on the secondary volume after the copy is completed.

In the configuration and operation, migration of the secondary volume can be performed in a state of maintaining the pair while preventing communication between the primary site and the secondary site.

As an example, a storage system includes a plurality of nodes each including a processor. A first node includes a primary volume configured to provide a logical storage area to a host. A second node includes a secondary volume configured to create a remote copy pair with the primary volume and sets the remote copy using identification information on the primary volume and identification information on the secondary volume. A third node includes a migration destination volume to be a migration destination when migration is performed with the primary volume as a migration source volume. The second node creates a new pair between the secondary volume and the migration destination volume when receiving a new pair creating request in which the identification information on the primary volume, the identification information on the secondary volume, and information identifying the third node are designated. The first node deletes the pair of the secondary volume and the primary volume and replaces the identification information on the migration destination volume with the identification information on the primary volume.

In the configuration and operation, migration of the primary volume can be performed in a state of maintaining the pair.

The invention is not limited to the above-described embodiments, and includes various modifications. For example, the embodiments described above have been described in detail to facilitate understanding of the invention, and the invention is not necessarily limited to those including all the configurations described above. The configurations may not only be deleted, but also be replaced or added.

What is claimed is:

1. A storage system comprising:
a plurality of nodes each including a processor, wherein a first node includes a primary volume configured to provide a logical storage area to a host,
a second node includes a secondary volume configured to create a remote copy pair with the primary volume and sets the remote copy using identification information on the primary volume and identification information on the secondary volume,
a third node includes a migration destination volume to be a migration destination when migration is performed with the secondary volume as a migration source volume,
the first node creates a new pair between the primary volume and the migration destination volume when receiving a new pair creating request in which the identification information on the primary volume, the identification information on the secondary volume, and information identifying the third node are designated, and
the second node deletes the pair of the secondary volume and the primary volume and replaces the identification information on the migration destination volume with the identification information on the secondary volume.

2. The storage system according to claim 1, wherein
after input/output to/from the secondary volume is made pending, the second node deletes the pair of the secondary volume and the primary volume, replaces the identification information on the migration destination volume with the identification information on the secondary volume, and cancels the pending.

3. The storage system according to claim 1, wherein
the first node further includes a first journal volume configured to accumulate a history of writing to the primary volume,
the third node further includes a third journal volume corresponding to the first journal volume after the migration, and
identification information on the third journal volume is used as information identifying the third node.

4. The storage system according to claim 1, wherein
the third node acquires a content in the primary volume from the first node and copies the content to the migration destination volume after the new pair is created, and
the second node deletes the pair of the secondary volume and the primary volume and replaces the identification information on the migration destination volume with the identification information on the secondary volume after the copy is completed.

5. The storage system according to claim 1, wherein
the third node acquires a content in the secondary volume from the second node and copies the content to the migration destination volume after the new pair is created, and
the second node deletes the pair of the secondary volume and the primary volume and replaces the identification information on the migration destination volume with the identification information on the secondary volume after the copy is completed.

6. A storage system comprising:
a plurality of nodes each including a processor, wherein
a first node includes a primary volume configured to provide a logical storage area to a host,
a second node includes a secondary volume configured to create a remote copy pair with the primary volume and sets the remote copy using identification information on the primary volume and identification information on the secondary volume,
a third node includes a migration destination volume to be a migration destination when migration is performed with the primary volume as a migration source volume,
the second node creates a new pair between the secondary volume and the migration destination volume when receiving a new pair creating request in which the identification information on the primary volume, the identification information on the secondary volume, and information identifying the third node are designated, and
the first node deletes the pair of the secondary volume and the primary volume and replaces the identification information on the migration destination volume with the identification information on the primary volume.

7. A method for managing a storage system including a plurality of nodes each including a processor, the method comprising:
providing a primary volume configured to provide a logical storage area to a host in a first node;
providing a secondary volume configured to create a remote copy pair with the primary volume in a second node and setting the remote copy using identification information on the primary volume and identification information on the secondary volume by the second node;
providing a migration destination volume to be a migration destination when migration is performed with the secondary volume as a migration source volume in a third node;
creating, by the first node, a new pair between the primary volume and the migration destination volume when receiving a new pair creating request in which the identification information on the primary volume, the identification information on the secondary volume, and information identifying the third node are designated; and
deleting the pair of the secondary volume and the primary volume and replacing the identification information on the migration destination volume with the identification information on the secondary volume, by the second node.

8. A method for managing a storage system including a plurality of nodes each including a processor, the method comprising:
providing a primary volume configured to provide a logical storage area to a host in a first node;
providing a secondary volume configured to create a remote copy pair with the primary volume in a second node and setting the remote copy using identification information on the primary volume and identification information on the secondary volume by the second node;
providing a migration destination volume to be a migration destination when migration is performed with the primary volume as a migration source volume in a third node;
creating, by the second node, a new pair between the secondary volume and the migration destination volume when receiving a new pair creating request in which the identification information on the primary volume, the identification information on the secondary volume, and information identifying the third node are designated; and
deleting the pair of the secondary volume and the primary volume and replacing the identification information on the migration destination volume with the identification information on the primary volume, by the first node.
